(19) United States
(12) Patent Application Publication
(10) Pub. No.: US 2025/0006405 A1
(43) Pub. Date: Jan. 2, 2025

(54) SUPERCONDUCTING WIRE

(71) Applicant: SUMITOMO ELECTRIC INDUSTRIES, LTD., Osaka (JP)

(72) Inventors: Takashi YAMAGUCHI, Osaka (JP); Genki HONDA, Osaka (JP)

(73) Assignee: SUMITOMO ELECTRIC INDUSTRIES, LTD., Osaka (JP)

(21) Appl. No.: 18/688,963

(22) PCT Filed: Jun. 22, 2022
(86) PCT No.: PCT/JP2022/024882

§ 371 Date: Mar. 4, 2024

(30) Foreign Application Priority Data
Sep. 15, 2021 (JP) 2021-150514

(51) Int. Cl. H01B 12/06

(52) U.S. Cl. CPC H01B 12/06

(57) ABSTRACT

A superconducting wire includes a superconducting layer. A material for constituting the superconducting layer is an oxide superconductor. In X-ray diffraction using a two-dimensional detector, a peak corresponding to a (200) plane of the oxide superconductor is defined as a first peak, a peak corresponding to a (006) plane of the oxide superconductor is defined as a second peak, and a peak corresponding to a (103) plane or a (013) plane of the oxide superconductor is defined as a third peak. A value obtained by dividing an intensity of the second peak by a sum of an intensity of the first peak, the intensity of the second peak, and an intensity of the third peak is more than or equal to 0.75.

### TECHNICAL FIELD

The present disclosure relates to a superconducting wire. The present application claims priority based on Japanese Patent Application No. 2021-150514 filed on Sep. 15, 2021. The entire contents described in the Japanese patent application are incorporated herein by reference.

### BACKGROUND ART

International Publication No. 2014/103995 (PTL 1) describes a superconducting wire. The superconducting wire described in PTL 1 has a base material, an intermediate layer, and an oxide superconducting layer. The intermediate layer is disposed on the base material, and the oxide superconducting layer is disposed on the intermediate layer. The material for constituting the oxide superconducting layer is EuBa₂Cu₃Oₓ.

### CITATION LIST

### Patent Literature

PTL 1: International Publication No. 2014/103995

### SUMMARY OF INVENTION

A superconducting wire of the present disclosure, a superconducting wire includes a superconducting layer. A material for constituting the superconducting layer is an oxide superconductor. In X-ray diffraction using a two-dimensional detector, a peak corresponding to a (200) plane of the oxide superconductor is defined as a first peak, a peak corresponding to a (006) plane of the oxide superconductor is defined as a second peak, and a peak corresponding to a (103) plane or a (013) plane of the oxide superconductor is defined as a third peak. A value obtained by dividing an intensity of the second peak by a sum of an intensity of the first peak, the intensity of the second peak, and an intensity of the third peak is more than or equal to 0.75.

### BRIEF DESCRIPTION OF DRAWINGS

FIG. 1 is a cross sectional view of a superconducting wire 100.

FIG. 2 is an example of measurement when X-ray diffraction using a two-dimensional detector is performed on a superconducting layer 20.

FIG. 3 is an example of measurement when X-ray diffraction using a zero-dimensional detector is performed on superconducting layer 20.

FIG. 4 is a scatter diagram showing the relation between a value obtained by dividing an intensity of a first peak by an intensity of a second peak, and a critical current density of superconducting layer 20.

### DETAILED DESCRIPTION

### Problem to be Solved by the Present Disclosure

In X-ray diffraction, an oxide superconducting layer shows a peak corresponding to a (200) plane of EuBa₂Cu₃Oₓ (a first peak) and a peak corresponding to a (006) plane of EuBa₂Cu₃Oₓ (a second peak). In the superconducting wire described in PTL 1, a critical current of the oxide superconducting layer is improved by setting a value obtained by dividing an intensity of a first peak by an intensity of a second peak (an a-axis ratio) to less than or equal to 0.015.

However, the superconducting wire described in PTL 1 has room for improvement in a critical current density of the oxide superconducting layer.

The present disclosure has been made in view of the problem of the conventional technique as described above. More specifically, the present disclosure provides a superconducting wire having an improved critical current density.

### Advantageous Effect of the Present Disclosure

According to the superconducting wire of the present disclosure, it can have an improved critical current density.

### DESCRIPTION OF EMBODIMENT OF THE PRESENT DISCLOSURE

First, an embodiment of the present disclosure will be described in list form.

(1) A superconducting wire in accordance with the embodiment includes a superconducting layer. A material for constituting the superconducting layer is an oxide superconductor. In X-ray diffraction using a two-dimensional detector, a peak corresponding to a (200) plane of the oxide superconductor is defined as a first peak, a peak corresponding to a (006) plane of the oxide superconductor is defined as a second peak, and a peak corresponding to a (103) plane or a (013) plane of the oxide superconductor is defined as a third peak. A value obtained by dividing an intensity of the second peak by a sum of an intensity of the first peak, the intensity of the second peak, and an intensity of the third peak is more than or equal to 0.75.

According to the superconducting wire described above in (1), it can have an improved critical current density.

(2) In the superconducting wire described above in (1), the superconducting layer may have a thickness of more than or equal to 1.0 μm and less than or equal to 4.5 μm.

According to the superconducting wire described above in (2), it is possible to secure a critical current while suppressing a decrease in critical current density.

(3) In the superconducting wire described above in (1) or (2), the superconducting layer may have a thickness of more than or equal to 1.5 μm and less than or equal to 4.5 μm.

According to the superconducting wire described above in (3), it can have both a high critical current density and a high critical current.

(4) In the superconducting wire described above in (1) to (3), a value obtained by dividing the intensity of the first peak by the intensity of the second peak may be less than 0.14.

According to the superconducting wire described above in (4), it can have an improved critical current density.

(5) In the superconducting wire described above in (1) to (3), a value obtained by dividing the intensity of the first peak by the intensity of the second peak may be more than or equal to 0.14.

According to the superconducting wire described above in (5), it can have an improved critical current density.

### Details of Embodiment of the Present Disclosure

Next, details of the embodiment of the present disclosure will be described with reference to the drawings. In the drawings below, identical or corresponding parts will be designated by the same reference numerals, and overlapping description will not be repeated.

(Configuration of Superconducting Wire in Accordance with Embodiment)

In the following, a configuration of the superconducting wire in accordance with the embodiment will be described. The superconducting wire in accordance with the embodiment is referred to as a superconducting wire 100.

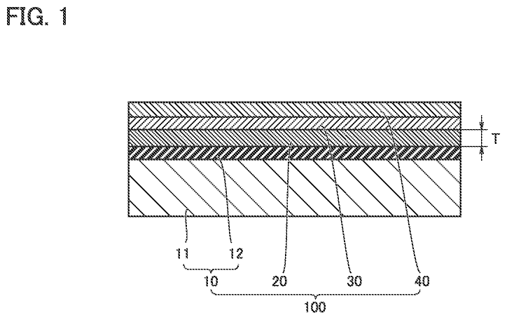

FIG. 1 is a cross sectional view of superconducting wire 100. As shown in FIG. 1, superconducting wire 100 has a substrate 10 and a superconducting layer 20.

Substrate 10 has a base material 11 and an intermediate layer 12. Intermediate layer 12 is disposed on base material 11. Base material 11 is a clad material in which a copper (Cu) layer and a nickel (Ni) layer are stacked on a tape made of stainless steel, for example. Intermediate layer 12 is a layer in which a cerium oxide (CeO₂) layer, a yttria stabilized zirconia (YSZ) layer, and a yttria (Y₂O₃) layer are stacked, for example. Intermediate layer 12 is formed by magnetron sputtering, for example.

The configuration of substrate 10 is not limited to the one described above. For example, base material 11 may be a tape made of Hastelloy (registered trademark), and intermediate layer 12 may be formed by IBAD (Ion Beam Assisted Deposition).

Superconducting layer 20 is disposed on substrate 10. More specifically, superconducting layer 20 is disposed on intermediate layer 12. The material for constituting superconducting layer 20 is an oxide superconductor. The material for constituting superconducting layer 20 is preferably a REBCO. The REBCO is an oxide superconductor represented by REBa₂Cu₃Oₓ, where RE is a rare earth element.

The rare earth element in the REBCO constituting superconducting layer 20 is at least one element selected from the group consisting of yttrium, lanthanum, neodymium, samarium, europium, gadolinium, dysprosium, holmium, erbium, thulium, lutetium, and ytterbium, for example.

As crystal grains constituting a lower layer of superconducting layer 20 are oriented, crystal grains constituting superconducting layer 20 are oriented. For example, when base material 11 has the copper layer described above, crystal grains of the copper layer are oriented by heat treatment. When substrate 10 has intermediate layer 12, crystal grains of an oxide constituting intermediate layer 12 need to have an orientation property. For example, when oriented intermediate layer 12 is formed by IBAD on base material 11 such as Hastelloy (registered trademark), crystal grains constituting superconducting layer 20 formed on intermediate layer 12 are oriented.

Superconducting layer 20 has a thickness T. Preferably, thickness T is more than or equal to 1.0 μm and less than or equal to 4.5 μm. More preferably, thickness T is more than or equal to 1.5 μm and less than or equal to 4.5 μm. A critical current is secured by setting thickness T to more than or equal to the lower limit value described above. A decrease in critical current density is suppressed by setting thickness T to less than or equal to the lower limit value described above. Superconducting layer 20 is formed by PLD (Pulsed Laser Deposition), for example. Superconducting layer 20 may be formed by MOD (Metal Organic Deposition), or may be formed by MOCVD (Metal Organic Chemical Vapor Deposition).

In X-ray diffraction using a two-dimensional detector, a peak corresponding to a (200) plane of the REBCO is defined as a first peak. In the X-ray diffraction using the two-dimensional detector, a peak corresponding to a (006) plane of the REBCO is defined as a second peak. In the X-ray diffraction using the two-dimensional detector, a peak corresponding to a (103) plane or a (013) plane of the REBCO is defined as a third peak. It should be noted that the (200) plane, the (006) plane, the (103) plane, and the (013) plane mean crystallographic crystal planes.

A value obtained by dividing an intensity of the second peak by a sum of an intensity of the first peak, the intensity of the second peak, and an intensity of the third peak is more than or equal to 0.75. That is, the relation that the intensity of the second peak/(the intensity of the first peak+the intensity of the second peak+the intensity of the third peak)≥0.75 is satisfied. Preferably, the value obtained by dividing the intensity of the second peak by the sum of the intensity of the first peak, the intensity of the second peak, and the intensity of the third peak is more than or equal to 0.8, or more than or equal to 0.9.

A value obtained by dividing the intensity of the first peak by the intensity of the second peak is less than 0.14, for example. The value obtained by dividing the intensity of the first peak by the intensity of the second peak may be less than or equal to 0.13, less than or equal to 0.12, or less than or equal to 0.10. The value obtained by dividing the intensity of the first peak by the intensity of the second peak may be more than or equal to 0.14. The value obtained by dividing the intensity of the first peak by the intensity of the second peak may be more than or equal to 0.15.

When superconducting layer 20 has a high orientation property, the intensity of the first peak and the intensity of the third peak may be less than or equal to a detection limit. In this case, the value obtained by dividing the intensity of the second peak by the sum of the intensity of the first peak, the intensity of the second peak, and the intensity of the third peak, and the value obtained by dividing the intensity of the first peak by the intensity of the second peak are calculated, assuming that the intensity of the first peak and the intensity of the third peak are 0.

In the X-ray diffraction using the two-dimensional detector, a crystal plane having a high orientation property of a measurement target is observed as a short arc-shaped diffraction image along a circumferential direction (χ direction), and a crystal plane having a low orientation property of the measurement target is observed as a ring-shaped diffraction image along the χ direction. In the X-ray diffraction using the two-dimensional detector, diffraction intensities of the crystal planes in the measurement target are obtained by adding the diffraction intensities of the crystal planes of the measurement target along the χ direction.

In X-ray diffraction using a zero-dimensional detector, a profile of diffraction intensity with respect to a diffraction angle 2θ in a measurement target is obtained. However, since a crystal plane having a low orientation property has a low diffraction intensity, a peak of the crystal plane having a low orientation property is less likely to be shown in this profile.

In the X-ray diffraction using the two-dimensional detector, when the REBCO constituting superconducting layer 20 is a-axis oriented, the first peak corresponding to the (200) plane appears intensely, and when the REBCO constituting superconducting layer 20 is c-axis oriented, the second peak corresponding to the (006) plane appears intensely. Further, in the X-ray diffraction using the two-dimensional detector, when the REBCO constituting superconducting layer 20 is not oriented, the third peak corresponding to the (103) plane or the (013) plane appears intensely.

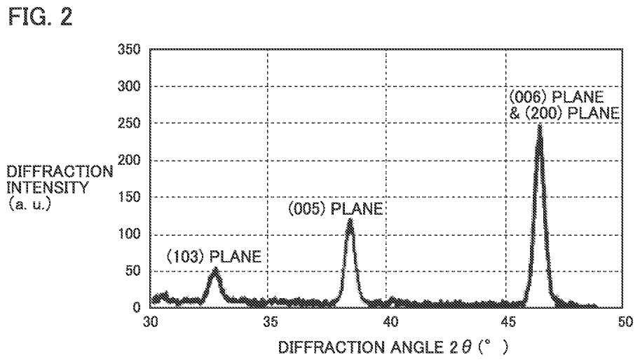

FIG. 2 is an example of measurement when the X-ray diffraction using the two-dimensional detector is performed on superconducting layer 20. As shown in FIG. 2, when the X-ray diffraction using the two-dimensional detector is performed, not only peaks corresponding to a (005) plane and the (006) plane of the REBCO showing a c-axis orientation but also a peak corresponding to the (103) plane showing a non c-axis orientation or a random orientation appear clearly in a profile of diffraction intensity with respect to diffraction angle 2θ. It should be noted that, as shown in FIG. 2, the peak corresponding to the (006) plane and a peak corresponding to the (200) plane may overlap and may be viewed as one peak. In such a case, this one peak can be separated into the peak corresponding to the (006) plane and the peak corresponding to the (200) plane by performing Gaussian fitting.

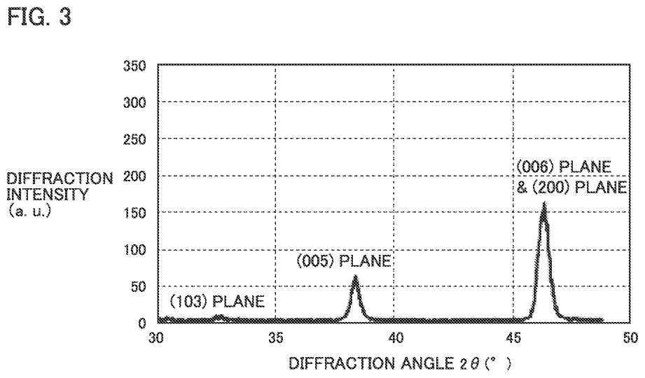

FIG. 3 is an example of measurement when the X-ray diffraction using the zero-dimensional detector is performed on superconducting layer 20. As shown in FIG. 3, when the X-ray diffraction using the zero-dimensional detector is performed, peaks corresponding to the (005) plane and the (006) plane of the REBCO appear clearly, whereas a peak corresponding to the (103) plane of the REBCO hardly appears in a profile of diffraction intensity with respect to diffraction angle 20.

Accordingly, by calculating the value obtained by dividing the intensity of the second peak by the sum of the intensity of the first peak, the intensity of the second peak, and the intensity of the third peak, the ratio of a c-axis oriented portion of the REBCO constituting superconducting layer 20 can be evaluated, also in consideration of a non-oriented portion of the REBCO constituting superconducting layer 20. It should be noted that the X-ray diffraction using the two-dimensional detector is performed using D8 DISCOVER (manufactured by Bryuker), and using CuKα (wavelength: 1.54060 angstroms) as a radiation source.

The value obtained by dividing the intensity of the second peak by the sum of the intensity of the first peak, the intensity of the second peak, and the intensity of the third peak is changed by adjusting a deposition condition of superconducting layer 20 as appropriate. For example, by adjusting a deposition temperature of superconducting layer 20 according to the thickness of superconducting layer 20 during deposition, the intensity of the third peak decreases, and the value obtained by dividing the intensity of the second peak by the sum of the intensity of the first peak, the intensity of the second peak, and the intensity of the third peak is increased.

Superconducting layer 20 has a critical current density (Jc) of more than or equal to 1.7 MA/cm², for example. Preferably, superconducting layer 20 has a critical current density of more than or equal to 2.6 MA/cm². It should be noted that the critical current density of superconducting layer 20 is measured during immersion in liquid nitrogen and under a self-magnetic field. “Under a self-magnetic field” refers to a state where there is no application of a magnetic field from outside. Superconducting layer 20 has a critical current (Ic) of more than or equal to 200 A, for example. Preferably, superconducting layer 20 has a critical current of more than or equal to 300 A. It should be noted that the critical current of superconducting layer 20 is measured with the width of superconducting wire 100 being set to 4 mm, and during immersion in liquid nitrogen and under a self-magnetic field.

As shown in FIG. 1, superconducting wire 100 may further have a protective layer 30 and a stabilization layer 40. The material for constituting protective layer 30 is silver (Ag), for example. The material for constituting protective layer 30 may be copper. Protective layer 30 is formed by sputtering, for example. Protective layer 30 is disposed on superconducting layer 20. The material for constituting stabilization layer 40 is copper, for example. Stabilization layer 40 is formed by plating, for example. Stabilization layer 40 is disposed on protective layer 30.

(Effect of Superconducting Wire in Accordance with Embodiment)

In the following, the effect of superconducting wire 100 will be described.

The present inventors' earnest studies have revealed that, when the ratio of the non-oriented portion of the REBCO constituting superconducting layer 20 increases, the critical current density of superconducting layer 20 decreases, even though the ratio of an a-axis oriented portion of the REBCO constituting superconducting layer 20 to the c-axis oriented portion of the REBCO constituting superconducting layer 20 (the value obtained by dividing the intensity of the first peak by the intensity of the second peak) is low.

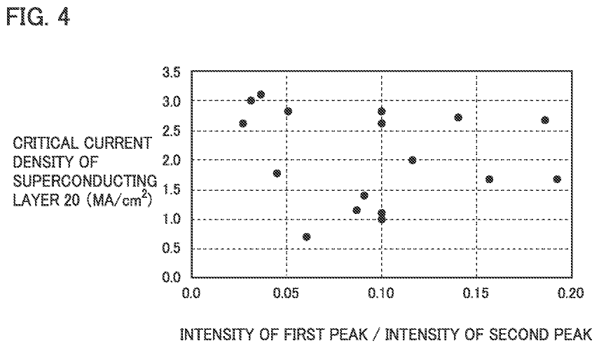

FIG. 4 is a scatter diagram showing the relation between the value obtained by dividing the intensity of the first peak by the intensity of the second peak, and the critical current density of superconducting layer 20. In FIG. 4, the axis of abscissas represents the value obtained by dividing the intensity of the first peak by the intensity of the second peak. In FIG. 4, the axis of ordinates represents the critical current density (unit: MA/cm²) of superconducting layer 20. As shown in FIG. 4, the critical current density of superconducting layer 20 hardly correlates with the value obtained by dividing the intensity of the first peak by the intensity of the second peak.

It is conceivable that this is because the value obtained by dividing the intensity of the first peak by the intensity of the second peak does not consider the non-oriented portion of the REBCO constituting superconducting layer 20. That is, this is because the value obtained by dividing the intensity of the first peak by the intensity of the second peak can increase, even though the ratio of the non-oriented portion of the REBCO constituting superconducting layer 20 is high.

When a c-axis direction of crystal grains of the oxide superconductor constituting superconducting layer 20 is oriented in a direction normal to a surface of substrate 10, a superconducting current flows in a longitudinal direction of superconducting wire 100. On the other hand, when an a-axis direction of the crystal grains of the oxide superconductor constituting superconducting layer 20 is oriented in the direction normal to the surface of substrate 10, or when the crystal grains of the oxide superconductor constituting superconducting layer 20 are randomly oriented, the superconducting current does not flow in the longitudinal direction of superconducting wire 100. That is, a-axis oriented crystal grains of the oxide superconductor serve as an obstructive factor against the superconducting current that flows in the longitudinal direction of superconducting wire 100, to the same extent as the randomly oriented crystal grains of the oxide superconductor. Accordingly, evaluation based on the value obtained by dividing the intensity of the first peak by the intensity of the second peak, that is, an a-axis ratio, does not necessarily serve as an appropriate evaluation on characteristics of superconducting layer 20.

The critical current density of superconducting layer 20 strongly correlates with the value obtained by dividing the intensity of the second peak by the sum of the intensity of the first peak, the intensity of the second peak, and the intensity of the third peak. In particular, the critical current density of superconducting layer 20 increases suddenly at a boundary where the value obtained by dividing the intensity of the second peak by the sum of the intensity of the first peak, the intensity of the second peak, and the intensity of the third peak is 0.75.

This is because the value obtained by dividing the intensity of the second peak by the sum of the intensity of the first peak, the intensity of the second peak, and the intensity of the third peak considers the non-oriented portion of the REBCO constituting superconducting layer 20. That is, when the ratio of the non-oriented portion of the REBCO constituting superconducting layer 20 is high, the value obtained by dividing the intensity of the second peak by the sum of the intensity of the first peak, the intensity of the second peak, and the intensity of the third peak does not increase even though the ratio of the c-axis oriented portion of the REBCO constituting superconducting layer 20 is high, and the critical current density of superconducting layer 20 does not increase.

In superconducting wire 100, the value obtained by dividing the intensity of the second peak by the sum of the intensity of the first peak, the intensity of the second peak, and the intensity of the third peak is more than or equal to 0.75, at which the critical current density of superconducting layer 20 increases suddenly. Accordingly, in superconducting wire 100, the critical current density of superconducting layer 20 is improved.

The present inventors' earnest studies have revealed a tendency that, as thickness T increases, the value obtained by dividing the intensity of the second peak by the sum of the intensity of the first peak, the intensity of the second peak, and the intensity of the third peak decreases, and as a result the critical current density decreases. On the other hand, as thickness T decreases, the critical current of superconducting layer 20 decreases. Accordingly, when thickness T is more than or equal to 1.5 μm and less than or equal to 4.5 μm, superconducting layer 20 can have both a high critical current density and a high critical current.

### EXAMPLE

In order to confirm the effect of superconducting wire 100, sample 1 to sample 17 were prepared as samples of the superconducting wire. In sample 1 to sample 17, the intensity of the first peak, the intensity of the second peak, and the intensity of the third peak, as well as thickness T were changed. For sample 1 to sample 17, measurement of the critical current density and the critical current was performed. It should be noted that, in sample 1 to sample 17, the width of superconducting layer 20 was set to 4 mm. Details of sample 1 to sample 17 are shown in Table 1.

TABLE 1

| Sample | 1 | 2 | 3 | 4 | 5 | 6 | 7 | 8 | 9 |
|---|---|---|---|---|---|---|---|---|---|
| Thickness T | 4.5 | 4.5 | 4 | 4 | 3 | 3 | 3 | 3 | 3 |
| (μm) | | | | | | | | | |
| (1) Intensity of | 15 | 45 | 20 | 10 | 25 | 30 | 15 | 20 | 20 |
| First Peak | | | | | | | | | |
| (2) Intensity of | 230 | 290 | 210 | 220 | 210 | 220 | 180 | 200 | 200 |
| Second Peak | | | | | | | | | |
| (1) ÷ (2) | 0.065 | 0.16 | 0.10 | 0.045 | 0.12 | 0.14 | 0.083 | 0.10 | 0.10 |
| (3) Intensity of | 120 | 50 | 70 | 60 | 35 | 15 | 60 | 30 | 75 |
| Third Peak | | | | | | | | | |
| (2) ÷ ((1) + (2) + (3)) | 0.63 | 0.75 | 0.70 | 0.76 | 0.78 | 0.83 | 0.71 | 0.80 | 0.68 |
| Critical Current | 0.7 | 1.7 | 1.1 | 1.8 | 2 | 2.7 | 1.2 | 2.6 | 1 |
| Density Jc | | | | | | | | | |
| (MA/cm²) | | | | | | | | | |
| Critical Current Ic | 129 | 307 | 181 | 288 | 235 | 329 | 141 | 312 | 119 |
| (A) | | | | | | | | | |

| Sample | 10 | 11 | 12 | 13 | 14 | 15 | 16 | 17 |
|---|---|---|---|---|---|---|---|---|
| Thickness T | 3 | 3 | 3 | 3 | 2 | 2 | 1.5 | 1 |
| (μm) | | | | | | | | |
| (1) Intensity of | 25 | 40 | 20 | 40 | 5 | 10 | 5 | 3 |
| First Peak | | | | | | | | |
| (2) Intensity of | 250 | 220 | 230 | 210 | 180 | 190 | 150 | 80 |
| Second Peak | | | | | | | | |
| (1) ÷ (2) | 0.10 | 0.18 | 0.087 | 0.19 | 0.03 | 0.053 | 0.033 | 0.038 |
| (3) Intensity of | 15 | 10 | 60 | 30 | 40 | 20 | 10 | 2 |
| Third Peak | | | | | | | | |
| (2) ÷ ((1) + (2) + (3)) | 0.86 | 0.81 | 0.74 | 0.75 | 0.80 | 0.86 | 0.9 | 0.94 |
| Critical Current | 2.8 | 2.7 | 1.4 | 1.7 | 2.6 | 2.8 | 3 | 3.1 |
| Density Jc | | | | | | | | |
| (MA/cm²) | | | | | | | | |
| Critical Current Ic | 337 | 322 | 170 | 205 | 210 | 227 | 213 | 125 |
| (A) | | | | | | | | |

As shown in Table 1, in sample 1, sample 3, sample 7, sample 9, and sample 12, the value obtained by dividing the intensity of the second peak by the sum of the intensity of the first peak, the intensity of the second peak, and the intensity of the third peak was less than 0.75. On the other hand, in sample 2, sample 4 to sample 6, sample 8, sample 10, sample 11, and sample 13 to sample 17, the value obtained by dividing the intensity of the second peak by the sum of the intensity of the first peak, the intensity of the second peak, and the intensity of the third peak was more than or equal to 0.75.

Further, in sample 1, sample 3, sample 7, sample 9, and sample 12, the critical current density was less than 1.7 MA/cm². On the other hand, in sample 2, sample 4 to sample 6, sample 8, sample 10, sample 11, and sample 13 to sample 17, the critical current density was more than or equal to 1.7 MA/cm². This comparison experimentally revealed that the critical current density of superconducting wire 100 is improved by setting the value obtained by dividing the intensity of the second peak by the sum of the intensity of the first peak, the intensity of the second peak, and the intensity of the third peak to more than or equal to 0.75.

In sample 6, sample 8, sample 10, sample 11, and sample 14 to sample 17, the value obtained by dividing the intensity of the second peak by the sum of the intensity of the first peak, the intensity of the second peak, and the intensity of the third peak was more than or equal to 0.8. In sample 6, sample 8, sample 10, sample 11, and sample 14 to sample 17, the critical current density was more than or equal to 2.6 MA/cm². This experimentally revealed that the critical current density of superconducting wire 100 is particularly improved by setting the value obtained by dividing the intensity of the second peak by the sum of the intensity of the first peak, the intensity of the second peak, and the intensity of the third peak to more than or equal to 0.8.

Further, in sample 2, sample 4 to sample 6, sample 8, sample 10, sample 11, and sample 13 to sample 16, thickness T was within a range of more than or equal to 1.5 μm and less than or equal to 4.5 μm. On the other hand, in sample 17, thickness T was less than 1.5 μm. In sample 2, sample 4 to sample 6, sample 8, sample 10, sample 11, and sample 13 to sample 16, the critical current density was more than or equal to 1.7 MA/cm², and the critical current was more than or equal to 200 A.

In sample 17, the critical current density was more than or equal to 1.7 MA/cm², whereas the critical current was less than 200 A. This comparison experimentally revealed that, when thickness T of more than or equal to 1.5 μm and less than or equal to 4.5 μm is further satisfied in addition to the value obtained by dividing the intensity of the second peak by the sum of the intensity of the first peak, the intensity of the second peak, and the intensity of the third peak being more than or equal to 0.75, superconducting wire 100 can have both a high critical current density and a high critical current.

In sample 2, sample 6, sample 11, and sample 13, the value obtained by dividing the intensity of the first peak by the intensity of the second peak was more than or equal to 0.14. On the other hand, in sample 4, sample 5, sample 8, sample 10, and sample 14 to sample 17, the value obtained by dividing the intensity of the first peak by the intensity of the second peak was less than 0.14.

As described above, in sample 2, sample 4 to sample 6, sample 8, sample 10, sample 11, and sample 13 to sample 17 in which the value obtained by dividing the intensity of the second peak by the sum of the intensity of the first peak, the intensity of the second peak, and the intensity of the third peak was more than or equal to 0.75, the critical current density was more than or equal to 1.7 MA/cm². Further, as described above, in sample 2, sample 4 to sample 6, sample 8, sample 10, sample 11, and sample 13 to sample 16 in which thickness T was within the range of more than or equal to 1.5 μm and less than or equal to 4.5 μm, the critical current was more than or equal to 200 A.

This comparison experimentally revealed that, as long as the value obtained by dividing the intensity of the second peak by the sum of the intensity of the first peak, the intensity of the second peak, and the intensity of the third peak is more than or equal to 0.75, the critical current density of superconducting wire 100 is improved, irrespective of whether the value obtained by dividing the intensity of the second peak by the intensity of the first peak is more than or equal to 0.14 or is less than 0.14.

Further, this comparison experimentally revealed that, as long as the value obtained by dividing the intensity of the second peak by the sum of the intensity of the first peak, the intensity of the second peak, and the intensity of the third peak is more than or equal to 0.75, and thickness T is within the range of more than or equal to 1.5 μm and less than or equal to 4.5 μm, superconducting wire 100 can have both a high critical current density and a high critical current, irrespective of whether the value obtained by dividing the intensity of the second peak by the intensity of the first peak is more than or equal to 0.14 or is less than 0.14.

It should be understood that the embodiment disclosed herein is illustrative and non-restrictive in every respect. The scope of the present invention is defined by the scope of the claims, rather than the embodiment described above, and is intended to include any modifications within the scope and meaning equivalent to the scope of the claims.

### REFERENCE SIGNS LIST

10: substrate; 11: base material; 12: intermediate layer; 20: superconducting layer; 30: protective layer; 40: stabilization layer; 100: superconducting wire; T: thickness.

1. A superconducting wire comprising:
a superconducting layer, wherein
a material for constituting the superconducting layer is an oxide superconductor,
in X-ray diffraction using a two-dimensional detector, a peak corresponding to a (200) plane of the oxide superconductor is defined as a first peak, a peak corresponding to a (006) plane of the oxide superconductor is defined as a second peak, and a peak corresponding to a (103) plane or a (013) plane of the oxide superconductor is defined as a third peak, and
a value obtained by dividing an intensity of the second peak by a sum of an intensity of the first peak, the intensity of the second peak, and an intensity of the third peak is more than or equal to 0.75.

2. The superconducting wire according to claim 1, wherein the superconducting layer has a thickness of more than or equal to 1.0 μm and less than or equal to 4.5 μm.

3. The superconducting wire according to claim 1, wherein the superconducting layer has a thickness of more than or equal to 1.5 μm and less than or equal to 4.5 μm.

4. The superconducting wire according to claim 1, wherein a value obtained by dividing the intensity of the first peak by the intensity of the second peak is less than 0.14.

5. The superconducting wire according to claim 1, wherein a value obtained by dividing the intensity of the first peak by the intensity of the second peak is more than or equal to 0.14.
